(19) United States
(12) Patent Application Publication
(10) Pub. No.: US 2006/0017762 A1
(43) Pub. Date: Jan. 26, 2006

(54) Device to determine a print medium type, image forming apparatus having the same, and method of determining a print medium type

(76) Inventor: Ho-bin Hwang, Suwon-si (KR)

Correspondence Address: STANZIONE & KIM, LLP, 919 18TH STREET, N.W., SUITE 440, WASHINGTON, DC, 20006, US

(21) Appl. No.: 11/155,548

(22) Filed: Jun. 20, 2005

(30) Foreign Application Priority Data
Jul. 22, 2004 (KR) 2004-57279

(51) Int. Cl. B41J 29/38

(52) U.S. Cl. 347/16

(57) ABSTRACT

A device to determine a print medium type, an ink-jet printer having the same, and a method of determining a print medium type using the same. The device includes a media sensor including a single light-emitting unit to emit a first incident light having and a single light-receiving unit to sense an intensity of light reflected from the first incident light, and a print medium-determining unit to compare the intensity of first reflected light with a first predetermined reference value and to determine the print medium accordingly. The method includes performing a primary sensing operation to sense an intensity of a first light reflected from a print medium by emitting a first incident light onto the print medium, and comparing the intensity of the first reflected light with a first predetermined reference value and determining the print medium accordingly.

### CROSS-REFERENCE TO RELATED APPLICATIONS

This application claims priority from Korean Patent Application No. 2004-57279, filed on Jul. 22, 2004, in the Korean Intellectual Property Office, the disclosure of which is incorporated herein in its entirety by reference.

### BACKGROUND OF THE INVENTION

1. Field of the Invention

The present general inventive concept relates to an ink-jet printer, and more particularly, to a device to determine a print medium type, an ink-jet printer having the same, and a method of determining a print medium type.

2. Description of the Related Art

In general, an ink-jet printer is a device in which ink is ejected from a printhead to a print medium to form an image. The printhead is mounted in a carrier that is moved along a widthwise direction of the print medium, which is transferred in a lengthwise direction thereof. There are several different types of print media including a paper (normal paper), a photopaper, a transparent paper, such as an overhead projector (OHP) film, or an ink-jet only paper having a coated print side to increase an ink absorption ability. In order to print a clear image on a variety of print media described above, a printing method should be set according to the type of print medium. Thus, a device for determining a print medium type and for discriminating among the different types of print media becomes necessary for use in the ink-jet printer.

FIG. 1 is a schematic diagram illustrating a conventional device for determining a print medium type in an ink-jet printer. Referring to FIG. 1, the conventional device for determining a print medium type discriminates among the types of print media according to differing optical reflection characteristics of the types of print media The conventional device for determining a print medium type comprises a media sensor 1 having a light-emitting unit 2, a first light-receiving unit 3, and a second light-receiving unit 4. The light-emitting unit 2 emits light incident on a print side of a print medium P, which is transferred along a direction indicated by an arrow during operation. The first light-receiving unit 3 is disposed in a first position to sense light that is properly reflected at a reflection angle that is equal to an incident angle of the emitted light. The second light-receiving unit 4 is disposed in a second position between the light-emitting unit 2 and the first light-receiving unit 3 to sense light that is reflected according to a disturbance in the print side of the print medium R

In the conventional device for determining a print medium type, light is emitted by the light-emitting unit 2, an intensity of properly reflected light and an intensity of light reflected according to a disturbance in the print side of print medium P are sensed by the first and second light-receiving units 3 and 4, respectively. The type of print medium is determined according to a ratio of the intensities of the light that is properly reflected and the light that is reflected according to a disturbance in the print side of the print medium P.

However, since the media sensor 1 of the conventional device for determining a print medium type requires a pair of light-receiving units 3 and 4 and the light-emitting unit 2 as described above, a print medium type cannot be determined by a general sensor having a single light-emitting unit and a single light-receiving unit. Thus, the conventional device for determining a print medium type is not effective.

### SUMMARY OF THE INVENTION

The present general inventive concept provides a device to determine a print medium type including a media sensor having a single light-receiving unit, an ink-jet printer having the same, and a method of determine a print medium using the same.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a device to determine a print medium type, comprising a media sensor including a single light-emitting unit to emit a first incident light onto a print medium and a single light-receiving unit to sense an intensity of light reflected from the first incident light by the print medium, and a print medium-determining unit to compare the sensed intensity of a first reflected light reflected from the first incident light with a first predetermined reference value and to determine the print medium accordingly. The first incident light may have an intensity that is stepwise increased.

The first predetermined reference value may be 60-90% of a maximum intensity of the first incident light.

The light-emitting unit of the media sensor may emit a second incident light onto the print medium. The device may further comprise a moving unit to move the media sensor along a widthwise direction of the print medium so that the media sensor emits the second incident light at a plurality of positions along the width of the print medium and senses a plurality of corresponding intensities of a second reflected light reflected from the second incident light by the print medium at each of the plurality of positions, a C-calculating unit to calculate a distribution factor C according to the plurality of corresponding intensities of the second reflected light, wherein the print medium-determining unit compares the distribution factor C with a second predetermined reference value to determine the print medium accordingly. The second incident light may have an intensity that is fixed at a predetermined value. The print medium-determining unit can determine whether the print medium is a photopaper according to the comparison of the intensity of the first reflected light with the first reference value and determine whether the print medium is a transparent paper, an ink-jet only paper, or a normal paper according to the comparison of the distribution factor C with the second reference value.

The plurality of corresponding intensities of the second reflected light may be combined into a plurality of groups of intensities having between 3 and 8 intensity values.

The light-emitting unit of the media sensor may be configured to emit the second incident light onto the print medium. The device may further comprise the moving unit to move the media sensor along a widthwise direction of the print medium so that the media sensor emits the second incident light at a plurality of positions along the width of the print medium and senses a plurality of corresponding intensities of light reflected from the second incident light by the print medium at each of the plurality of positions, a V1-calculating unit to calculate a first variance V1 of the plurality of corresponding intensities by filtering the sensed plurality of corresponding intensities with respect to a first frequency area, and an ink-jet only paper-determining unit to determine that the print medium is an ink-jet only paper if the first variance V1 is less than a boundary value V1m of the first variance V1. The second incident light may have an intensity that is fixed at a predetermined value.

The first frequency area may be between 50 Hz and 100 Hz.

The light-emitting unit of the media sensor may be configured to emit the second incident light onto the print medium. The device may further comprise the moving unit to move the media sensor along a widthwise direction of the print medium so that the media sensor emits the second incident light at a plurality of positions along the width of the print medium and senses a plurality of corresponding intensities of light reflected from the second incident light by the print medium at each of the plurality of positions, a V2-calculating unit to calculate a second variance V2 of the plurality of corresponding intensities by filtering the sensed plurality of corresponding intensities with respect to a second frequency area, and a transparent paper-determining unit to determine that the print medium is a transparent paper if the second variance V2 is larger than a boundary value V2m of the second variance V2. The second incident light may have an intensity that is fixed at a predetermined value.

The second frequency area may be between 0 Hz and 5 Hz.

The foregoing and/or other aspects and advantages of the present general inventive concept may also be achieved by providing an image forming apparatus comprising a printer to print an image on a print medium and a device to determine a print medium type, the device to determine the print medium type comprising a media sensor including a single light-emitting unit to emit a first incident light onto a print medium and a single light-receiving unit to sense an intensity of light reflected from the first incident light by the print medium, and a print medium-determining unit to compare the intensity of the light reflected from the first incident light with a first predetermined reference value and to determine the print medium accordingly. The first incident light may have an intensity that is stepwise increased.

The first predetermined reference value may be 60-90% of a maximum intensity of the first incident light.

The light-emitting unit of the media sensor may be configured to emit a second incident light having an intensity fixed at a predetermined value onto the print medium. The apparatus may further comprise a moving unit to move the media sensor along a widthwise direction of the print medium so that the media sensor emits the second incident light at a plurality of positions along the width of the print medium and senses a plurality of corresponding intensities of light reflected from the second incident light by the print medium at each of the plurality of positions, a C-calculating unit to calculate a distribution factor C according the plurality of corresponding intensities of the second reflected light, wherein the print medium-determining unit compares the distribution factor C with a second predetermined reference value to determine the print medium as a transparent paper, an ink-jet only paper, or a normal paper.

The plurality of corresponding intensities of the second reflected light may be combined into a plurality of groups of intensities having between 3 and 8 intensity values.

The light-emitting unit of the media sensor may be configured to emit the second incident light onto the print medium. The apparatus may further comprise the moving unit to move he media sensor along a widthwise direction of the print medium so that the media sensor emits a second incident light at a plurality of positions along the width of the print medium and senses a plurality of corresponding intensities of light reflected from the second incident light by the print medium at each of the plurality of positions, a V1-calculating unit to calculate a first variance V1 of the plurality of corresponding intensities by filtering the sensed plurality of corresponding intensities with respect to a first frequency area, and an ink-jet only paper-determining unit to determine that the print medium is an ink-jet only paper if the first variance V1 is less than a boundary value V1m of the first variance V1. The second incident light may have an intensity that is fixed at a predetermined value.

The first frequency area may be between 50 Hz and 100 Hz.

The light-emitting unit of the media sensor may be configured to emit the second incident light onto the print medium. The apparatus may further comprise the moving unit to move the media sensor along a widthwise direction of the print medium so that the media sensor emits the second incident light at a plurality of positions along the width of the print medium and senses a plurality of corresponding intensities of light reflected from the second incident light by the print medium at each of the plurality of positions, a V2-calculating unit to calculate a second variance V2 of the plurality of corresponding intensities by filtering the sensed plurality of corresponding intensities with respect to a second frequency area, and a transparent paper-determining unit to determine that the print medium is a transparent paper if the second variance V2 is greater than a boundary value V2m of the second variance V2. The second incident light may have an intensity that is fixed at a predetermined value.

The second frequency area may be between 0 Hz and 5 Hz.

The foregoing and/or other aspects and advantages of the present general inventive concept may also be achieved by providing a method of determining a print medium type, the method comprising performing a primary sensing operation to sense an intensity of a first reflected light reflected from a print medium by emitting a first incident light onto the print medium, and comparing the intensity of the first reflected light with a first predetermined reference value and determining the print medium accordingly. The first incident light may have an intensity that is stepwise increased.

The first predetermined reference value may be 60-90% of a maximum intensity of the first incident light.

The method may further comprise performing a secondary sensing operation to sense a plurality of intensities of a second reflected light reflected from each of a plurality of positions along the print medium by emitting a second incident light at the plurality of positions along the width of the print medium, calculating a distribution factor C according to the sensed plurality of intensities of the second reflected light, and comparing the distribution factor C with a second predetermined reference value and determining that the print medium is a transparent paper, an ink-jet only paper, or a normal paper accordingly. The second incident light may have an intensity that is fixed at a predetermined value.

The plurality of intensities of the second reflected light may be combined into a plurality groups of intensities having between 3 and 8 intensity values.

The method may further comprise performing the secondary sensing operation to sense an intensity of the second reflected light reflected from each of a plurality of positions along the print medium by emitting the second incident light at the plurality of positions along the width of the print medium, calculating a first variance V1 of the plurality of intensities of the second reflected light by filtering the sensed plurality of intensities of the second reflected light with respect to a first frequency area, and determining that the print medium is an ink-jet only paper if the first variance V1 is less than a boundary value V1m of the first variance V1. The second incident light may have an intensity that is fixed at a predetermined value.

The first frequency area may be between 50 Hz and 100 Hz.

The method may further comprise performing the secondary sensing operation to sense a plurality of intensities of the second light reflected from each of a plurality of positions along the print medium by emitting the second incident light at the plurality of positions along the width of the print medium, calculating a second variance V2 of the plurality of intensities of the second reflected light by filtering the sensed plurality of intensities of the second reflected light with respect to a second frequency area, and determining that the print medium is a transparent paper if the second variance V2 is greater than a boundary value V2m of the second variance V2. The second incident light may have an intensity that is fixed at a predetermined value.

The second frequency area may be between 0 Hz and 5 Hz.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram illustrating a conventional device for determining a print medium type in an ink-jet printer;

FIG. 2 is a schematic diagram illustrating a device to determine a print medium type according to an embodiment of the present general inventive concept;

FIG. 3 is a schematic diagram illustrating a portion of an ink-jet printer having the device to determine a print medium type of FIG. 2 according to an embodiment of the present general inventive concept;

FIG. 4 is a conceptual diagram illustrating a microprocessor of the device to determine a print medium type of FIG. 2 according to an embodiment of the present general inventive concept;

FIG. 5 is a conceptual diagram illustrating a microprocessor of the device to determine a print medium type of FIG. 2 according to another embodiment of the present general inventive concept;

FIG. 6 is a flowchart illustrating a method of determining a print medium type according to an embodiment of the present general inventive concept;

FIG. 7 is a flowchart illustrating a method of determining a print medium type according to another embodiment present general inventive concept;

FIG. 8 is a graph illustrating intensities of reflected light sensed by emitting a second incident light at 4000 positions along a width of a print medium;

FIG. 9 illustrates a method of calculating a distribution factor C;

FIG. 10 is a graph illustrating a distribution factor C with respect to each print medium;

FIG. 11 is a graph illustrating a first variance V1 with respect to each print medium; and

FIG. 12 is a graph illustrating a second variance V2 with respect to each print medium.

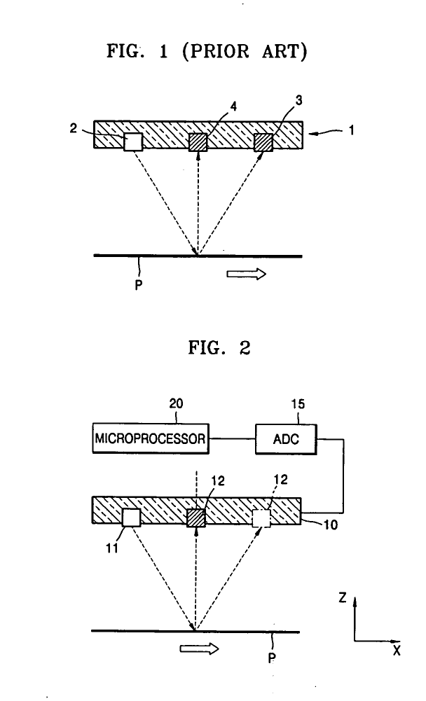

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

Referring to FIG. 2, a device to determine a print medium type according to an embodiment of the present general inventive concept comprises a media sensor 10, an analog to digital converter 15, and a microprocessor 20.

The media sensor 10 includes a light-emitting unit 11 to emit a first incident light having a stepwise increasing intensity or a second incident light having an intensity fixed at a predetermined value onto a print medium P, and a light-receiving unit 12 to sense an intensity of first and second reflected light reflected from the first and second incident light. As illustrated in FIG. 2, the media sensor 10 is positioned above the print medium P, which is transferred along an X-direction during operation. The light-emitting unit 11 may include a light-emitting diode (LED). A signal input into the LED is adjusted by pulse width modulation (PWM) so that an intensity of incident light of the light-emitting unit 11 can be at a constant level that can be increased or decreased. The light-emitting unit 11 emits the incident light toward the print medium P at an incidence angle The light-receiving unit 12 is disposed at a position in the media sensor 10 that is directly above a light incidence position (i.e., where the light emitted by the light-emitting unit 11 is incident on the print medium P). In other words, the light-receiving unit 12 and the light incidence position form a line that is perpendicular to the print medium P. This arrangement is illustrated in FIG. 2 by a first dotted line arrow that is perpendicular to the print medium P. However, as indicated by a second dotted line arrow in FIG. 2 having a non-right angle with respect to the print medium P, the light-receiving unit 12 may alternatively be disposed at a second position in the media sensor 10 that is at an angle with respect to the light incidence position and the print medium P. The second position is indicated by a dotted line square 12 in the media sensor 10. An angle between the second dotted line arrow and the print medium P may be equal to the incidence angle of the light emitted by the light-emitting unit 11. As described above, since the media sensor 10 comprises the single light-emitting unit 11 and the single light-receiving unit 12, an alignment sensor of an ink-jet printer may be used as the media sensor 10.

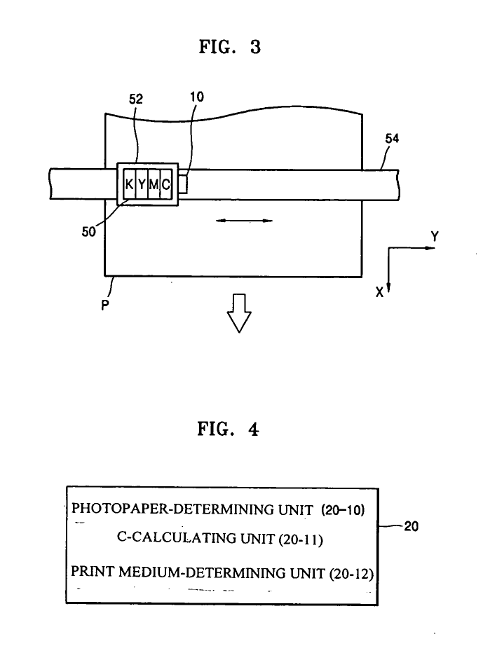

Referring to FIG. 3, the media sensor 10 is installed on a carrier 52 in which a printhead 50 of an ink-jet printer is mounted. The carrier 52 is guided by a guide 54 and is reciprocated by a moving unit (not shown) in a widthwise direction of the print medium P, (i.e., a Y-direction). Thus, the media sensor 10 that is installed on the carrier 52 may be reciprocated in the Y-direction. As described above, the media sensor 10 moves in the widthwise direction of the print medium P, emits a second incident light at a plurality of positions set at equal intervals along the width of the print medium P, and senses a plurality of corresponding intensities of the second reflected light by the print medium P.

A Y-direction position of the media sensor 10 can be determined by a position encoder. Since the position encoder determines a Y-direction position of the printhead 50 used during printing operations, an additional position encoder is not needed to determine the Y-direction position of the media sensor 10.

The ADC 15 converts an analog signal that indicates the intensities of the first or second reflected light sensed by the light-receiving unit 12 into a digital signal.

FIG. 4 is a conceptual diagram illustrating a microprocessor 20 of the device to determine a print medium type of FIG. 2 according to an embodiment of the present general inventive concept. Referring to FIG. 4, the microprocessor 20 comprises a photopaper-determining unit 20-10, a C-calculating unit 20-11, and a print medium-determining unit 20-12 that determines the print medium type according to a distribution factor C that indicates a distribution of the plurality of corresponding intensities of the second reflected light for each of the different types of print media.

When the first incident light is emitted onto the print medium P by the light-emitting unit 11 (FIG. 2) and an intensity of the first reflected light reflected by the print medium P to the light-receiving unit 12 reaches a first reference value, the photopaper-determining unit 20-10 determines that the print medium P is a photopaper. The first reference value may be set to 60-90% of a maximum intensity of the first incident light which the light-emitting unit 11 of the media sensor 10 emits. However, if the first reference value is set to be less than 60% of the maximum intensity of the first incident light, the print medium P may be incorrectly determined as another type of print medium P. For example, the print medium P may be incorrectly determined as a transparent paper instead of the photopaper. Additionally, if the first reference value is set to be greater than 90% of the maximum intensity of the first incident light, the print medium P may not be able to be determined to be the photopaper, since the photopaper may be incapable of reflecting 90% of the first incident light to the light-receiving unit 12 (see FIG. 2).

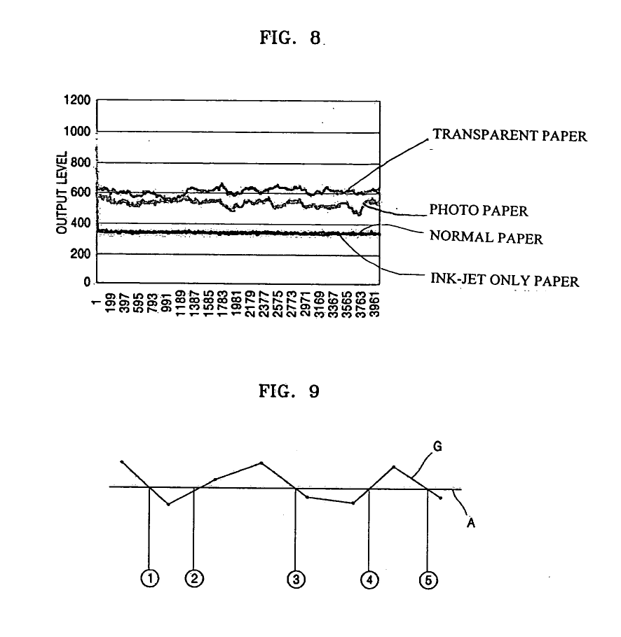

FIG. 8 is a graph illustrating intensities of the second reflected light sensed by emitting the second incident light at 4000 positions set along a width of a print medium, and FIG. 9 illustrates a method of calculating the distribution factor C.

The distribution factor C is determined after emitting the second incident light at 4000 positions along the width of the print medium P (see FIG. 2) and sensing corresponding intensities of the second reflected light reflected from the second incident light. In other words, the light-emitting unit 11 (see FIG. 2) of the media sensor 10 (see FIG. 2) emits the second incident light at 4000 positions and the light-receiving unit 12 (see FIG. 2) of the media sensor 10 measures the corresponding intensities of the second reflected light. FIG. 8 illustrates the graph including the intensities measured by the light-receiving unit 12 of the media sensor 10 that correspond to the second incident light emitted at the 4000 corresponding positions. In particular FIG. 8 illustrates the measured intensities for the different types of print media usable with the present general inventive concept.

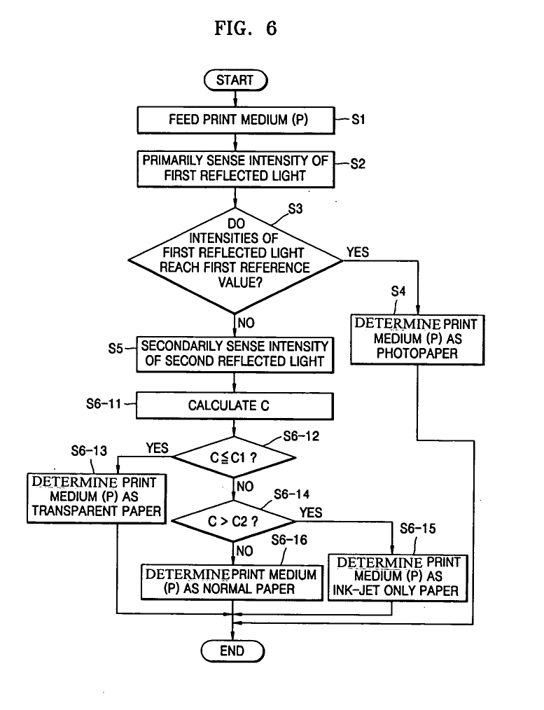

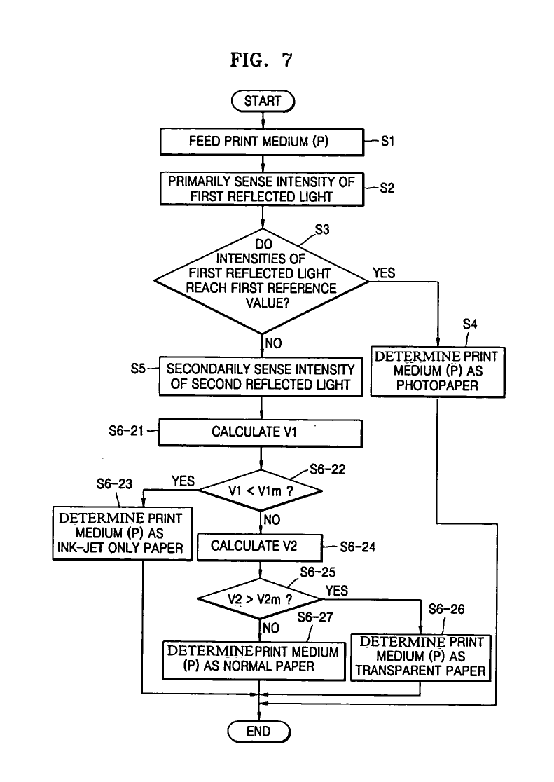

For example, as illustrated in FIG. 8, the photopaper reflects the largest amount of the second incident light to the light-receiving unit 12 and has the highest average intensity of the second reflected light of all the different types of print media. The transparent paper has the second highest average intensity of second reflected light. The normal paper and the ink-jet only paper have similar average intensities of the second reflected light. Since the normal paper and the ink-jet only paper have similar average intensities, it may be difficult to discriminate between the two using only the average value of the measured intensities of the second reflected light. As described below with reference to FIGS. 6, 8, and 9, the normal paper can be discriminated from the ink-jet only paper according to the distribution factor C of the intensities of the second reflected light. Alternatively, as described below with reference to FIGS. 7 and 8, the normal paper can be discriminated from the ink-jet only paper by filtering a frequency of the intensities of the second reflected light and determining a variance.

As illustrated in FIG. 9, the distribution factor C can be defined for each of the different types of print media by plotting groups of adjacent intensities of the second reflected light as a scatter line “G” with respect to a straight line “A” representing an average intensity over the 4000 positions along the width of the print medium P. A number of times in which groups of adjacent intensities of the second reflected light represented by the scatter line “G” cross the average intensity line “A” over the 4000 positions is equal to the distribution factor C. More specifically, the intensities of the second reflected light are combined into groups of intensities having a predetermined size. For example, the groups of intensities may include three adjacent intensities (e.g., intensity at a second position, intensity at a third position, and intensity at a fourth position). An average value of the intensities of second reflected light of each group of the predetermined size (i.e., three) is calculated as a representative intensity value and the scatter line plot “G” is graphed by connecting the representative intensity value of each group by a line. The line “A” having an average value of the intensities of second reflected light over the 4000 positions is also plotted. The number of times that “G” crosses “A” is determined to be a value of the distribution factor C. The C-calculating unit 20-11 (see FIG. 4) calculates the value of C by performing an arithmetic operation.

Thus, data about adjacent intensities of the second reflected light are combined into a plurality of groups having a predetermined size. The representative intensity value of each group is then calculated.

For example, a first value, a second value, a third value, a fourth value, . . . , and a 4000-th value are combined into groups having three intensity values. The groups of adjacent intensities may include a group having a combination of a first intensity value, a second intensity value, a third intensity value, a group having a combination of a second intensity value, a third intensity value, a fourth intensity value, . . . , and a group having a combination of a 3998-th intensity value, a 3999-th intensity value, 4000-th intensity value. The representative intensity value of each group is then calculated. Next, the representative intensity value of each group is plotted, and adjacent plots are connected to one another to form the scatter line plot “G” in FIG. 9. Also as illustrated in FIG. 9, the line “A” is plotted according to the average value of intensities of the second reflected light. Next, as indicated by intersection points 1, 2, 3, 4, and 5 in FIG. 9, C can be calculated by adding the number of times that “G” crosses “A.”

Although FIGS. 8 through 11 describe the second reflected light being emitted at 4000 positions along the width of the print medium P to determine a type of print medium, it should be understood that the print medium can be determined by emitting light at less than 4000 positions or more than 4000 positions. Additionally, although FIGS. 8 and 9 illustrate that the intensities of the second reflected light are combined into groups of three adjacent intensities, other predetermined sizes of groups may alternatively be used.

If the predetermined size of the groups is equal to or less than 2, large variations occur in “G.” Accordingly, all values of the distribution factor C corresponding to the different types of print media increase, a difference in the values of the distribution factor C between the different types of print media is reduced, and errors may occur in discrimination among the different types of print media. On the other hand, if the predetermined size of the groups is equal to or greater than 9, variations in “G” are smaller. Accordingly, all values of the distribution factor C corresponding to the different types of print media decrease, a difference in the values of the distribution factor C between the different types of print media is reduced, and errors may occur in discrimination among the different types of print media. Accordingly, the predetermined size of the groups may be set between 3 and 8 intensity values.

The print medium-determining unit 20-12 (see FIG. 4) that determines the type of print medium according to the distribution factor C determines that the print medium P is a transparent paper if the distribution factor C is less than or equal to a first boundary value C1. If the distribution factor C is greater than a second boundary value C2, which is greater than the first boundary value C1, the print medium-determining unit 20-12 determines that the print medium P is an ink-jet only paper. In addition, if the distribution factor C is greater than the first boundary value C1 and less than or equal to the second boundary value C2, the print medium-determining unit 20-12 determines that the print medium P is a normal paper.

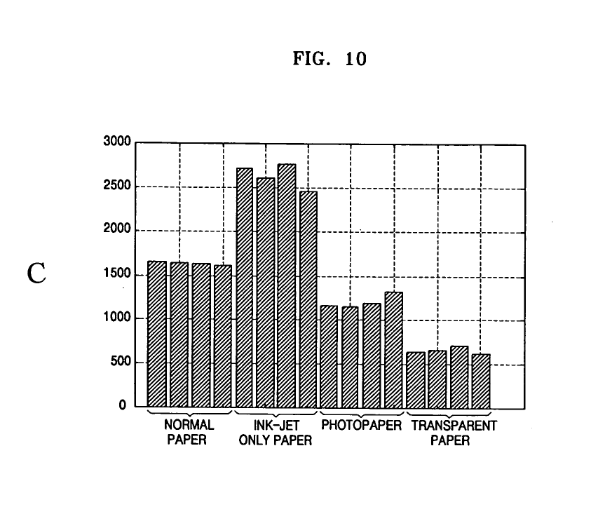

FIG. 10 is a graph illustrating a value of the distribution factor C with respect to the different types of print media when intensities of the second reflected light are combined into groups of three intensity values and the distribution factor C is calculated with respect to a normal paper, an ink-jet only paper, a photopaper, and a transparent paper. Referring to FIG. 10, the distribution factor C of the ink-jet only paper exceeds 2000, the distribution factor C of the normal paper and the photopaper fall between 1000 and 2000, and the distribution factor C of the transparent paper is less than 1000.

Since the device to determine a print medium type can determine whether the print medium P is the photopaper by determining whether the intensity of the light reflected to the light-receiving unit 12 from the first incident light is greater than the first reference value, which is a percentage of the maximum intensity of the first incident light, the distribution factor C may only need to be calculated when the print medium P can not be determined to be the photopaper. If the print medium P is determined not to be the photopaper, the print medium P is determined as one of the normal paper, the transparent paper, and the ink-jet only paper according to the distribution factor C using the second incident light reflected at the plurality of positions along the width of the print medium P Thus, if the first boundary value C1 is set to 1000 and the second boundary value C2 is set to 2000, the print medium P can be properly determined as the normal paper, the ink-jet only paper, or the transparent paper.

FIG. 6 illustrates a method of determining a print medium type according to an embodiment of the present general inventive concept. The method of FIG. 6 will now be described with reference to FIGS. 2 and 4.

If the print medium P (see FIG. 2) is fed into an ink-jet printer in operation S1, the media sensor 10 (see FIG. 2) senses the print medium P in a primary sensing process of operation S2. In the primary sensing process of operation S2, the media sensor 10 emits the first incident light onto the print medium P and senses an intensity of a first reflected light, which is light reflected from the first incident light by the print medium P If the intensity of the first reflected light reaches a first predetermined reference value in operation S3, the photopaper-determining unit 20-10 (see FIG. 4) determines that the print medium P is a photopaper in operation S4. However, if the intensity of the first reflected light does not reach the first reference value, the media sensor 10 senses the print medium P according to a secondary sensing process in operation S5. In the secondary sensing process of operation S5, the media sensor 10 emits a second incident light at a plurality of positions along the width of the print medium P onto the print medium P and senses an intensity of the second reflected light reflected from each of the positions along the width of the print medium P. The first incident light may have an intensity that is increased stepwise, and the second incident light has an intensity that is fixed at a predetermined value.

The C-calculating unit 20-11 (see FIG. 4) calculates the distribution factor C by performing an arithmetic operation in operation S6-11, and the print medium-determining unit 20-12 (see FIG. 4) determines the print medium P according to the distribution factor C, by comparing the distribution factor C with the first and second boundary values C1 and C2. If the distribution factor C is less than or equal to the first boundary value C1 in operation S6-12, the print medium-determining unit 20-12 determines that the print medium P is the transparent paper in operation S6-13. If the distribution factor C is greater than the second boundary value C2 in operation S6-14, the print medium-determining unit 20-12 determines that the print medium P is the ink-jet only paper in operation S6-15. If the distribution factor C is greater than the first boundary value C1 and less than or equal to the second boundary value C2, the print medium determining unit 20-12 determines that the print medium P is the normal paper in operation S6-16.

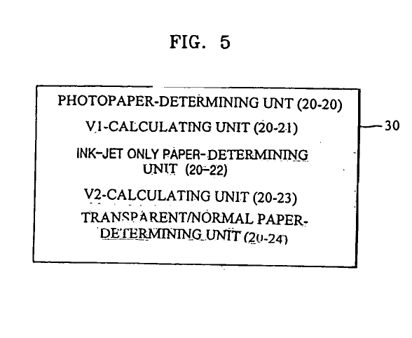

FIG. 5 is a conceptual diagram illustrating a microprocessor 30 of the device to determine a print medium type according to another embodiment of the present general inventive concept. Referring to FIG. 5, the microprocessor 30 comprises a photopaper-determining unit 20-20, a V1-calculating unit 20-21, an ink-jet only paper-determining unit 20-22, a V2-calculating unit 20-23, and a transparent/normal paper-determining unit 20-24.

When the first incident light is emitted onto the print medium P by the light-emitting unit 11 (FIG. 2) and the intensity of the first reflected light (i.e., an intensity of light reflected from the first incident light reflected by the print medium P to the light receiving unit 12 (FIG. 2)) reaches a first reference value, the photopaper-determining unit 20-20 determines that the print medium P is a photopaper. The first reference value may be set to 60-90% of the intensity of maximum incident light which the light-emitting unit 11 of the media sensor 10 emits.

The V1-calculating unit 20-21 calculates V1, which is a first variance of a value calculated by filtering the intensities of the second reflected light (see FIG. 8) sensed by the light-receiving unit 12 of the media sensor 10 with respect to a first frequency area.

The variance can be defined as an average value of a square of a standard deviation. Since one of ordinary skill should be able to calculate the first variance V1 from this definition, a detailed description thereof will not be provided.

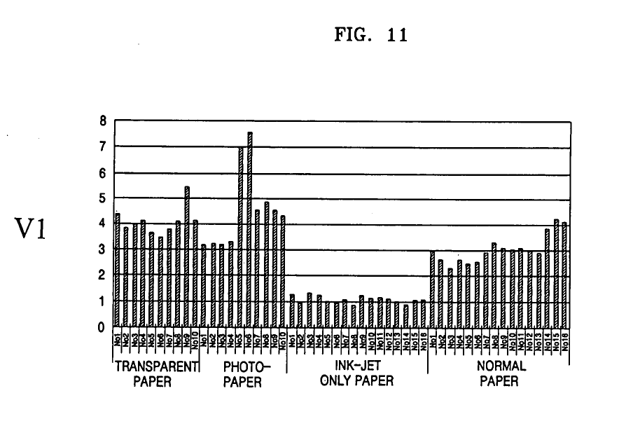

The ink-jet only paper-determining unit 20-22 determines that the print medium P is an ink-jet only paper if the first variance V1 is less than a boundary value V1m. Referring to FIG. 8, it can be determined that a graph on which the intensities of the second reflected light are plotted illustrates more high frequency components when the print medium is the ink-jet only paper than when the print medium is the normal paper, the photopaper, or the transparent paper. FIG. 11 is a graph illustrating the first variance V1 for the different types of print media determined by filtering the graph of the intensities of the second reflected light in an intermediate frequency area (i.e., an area between 50 Hz and 100 Hz). Referring to FIG. 11, it can be determined through several repeated experiments that the first variance V1 when the print medium is the ink-jet only paper is substantially lower than the first variance V1 when the print medium is the transparent paper, the photopaper, or the normal paper. Thus, when a first frequency area is between 50 Hz and 100 Hz (i.e., the intermediate frequency area) and the boundary value V1m is set to 1.5, it can be correctly determined whether the print medium P is the ink-jet only paper.

The V2-calculating unit 20-23 calculates a second variance V2, which is a second variance of a value calculated by filtering the intensities of the second reflected light sensed by the light-receiving unit 12 of the media sensor 10 with respect to a second frequency area. Since one or ordinary skill in the art should be able to calculate the second variance V2 from this definition, a detailed description thereof will not be provided.

The transparent/normal paper-determining unit 20-24 determines that the print medium P is the transparent paper if the second variance V2 is greater than a boundary value V2m. In addition, if the second variance V2 is less than or equal to the boundary value V2m, the transparent/normal paper-determining unit 20-24 determines that the print medium P is the normal paper.

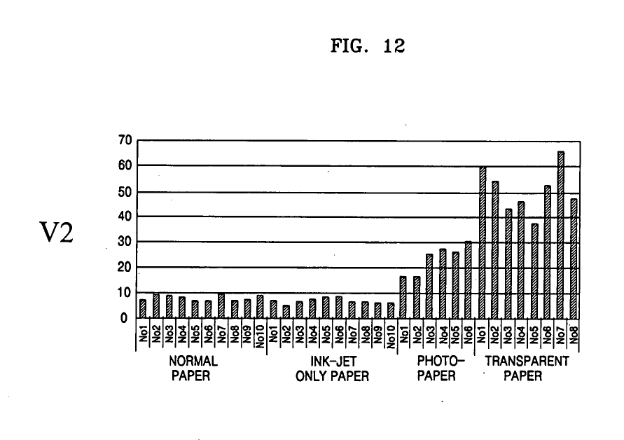

Referring to FIG. 8, it can be determined that a graph on which the intensities of the second reflected light are plotted illustrates more low frequency components when the print medium is the transparent paper or the photopaper than when the print medium is the normal paper or the ink-jet only paper. FIG. 12 is a graph illustrating the second variance V2 for the different types of print media determined by filtering the graph of the intensities of the second reflected light in a low frequency area (i.e., an area between 0 Hz and 5 Hz). Referring to FIG. 12, it can be determined through several repeated experiments that the second variance V2 when the print medium is the normal paper or the ink-jet only paper is substantially lower than the second variance V2 when the print medium is the transparent paper or the photopaper.

V2 need only be calculated when the print medium P is not determined to be the photopaper or the ink-jet only paper. If the print medium is not determined to be the photopaper or the ink-jet only paper, the second variance V2 is calculated, and the print medium is determined using the second variance V2. Thus, when the boundary value V2m is set to 12, it can be correctly determined whether the print medium P is the transparent paper or the normal paper.

FIG. 7 is a flowchart illustrating a method of determining a print medium type according another embodiment of the present general inventive concept. The method of FIG. 7 will now be described with reference to FIGS. 2 and 5.

If the print medium P (see FIG. 2) is fed into an ink-jet printer in operation S1 the media sensor 10 (see FIG. 2) senses the print medium P in a primary sensing process of operation S2. In the primary sensing process of operation S2, the media sensor 10 emits a first incident light having an intensity increased stepwise onto the print medium P and senses an intensity of a first reflected light, which is light reflected from the first incident light by the print medium P. If the intensity of the first reflected light reaches a first predetermined reference value in operation S3, the photopaper-determining unit 20-20 (see FIG. 5) determines that the print medium P is a photopaper in operation S4. However, if the intensity of the first reflected light does not reach the first reference value, the media sensor 10 senses the print medium P according to a secondary sensing process in operation S5. In the secondary sensing process of operation S5, the media sensor 10 emits a second incident light at a plurality of positions along the width of the print medium P onto the print medium P and senses an intensity of a second reflected light reflected from each of the positions along the width of the print medium P. The second incident light has an intensity that is fixed at a predetermined value.

The V1-calculating unit 20-21 (see FIG. 5) calculates V1 by performing an arithmetic operation in operation S6-21, and the ink-jet only paper-determining unit 20-22 (see FIG. 5) determines whether the print medium is the ink-jet only paper by comparing the first variance V1 with the boundary value V1m of the first variance V1. If the first variance V1 is less than the boundary value V1m in operation S6-22, the ink-jet only paper-determining unit 20-22 determines that the print medium P is the ink-jet only paper in operation S6-23. If the first variance V1 is greater than or equal to the boundary value V1m, a V2-calcuating unit 20-23 (see FIG. 5) calculates a second variance V2 by performing a second arithmetic operation in operation S6-24. The transparent/normal paper-determining unit 20-24 (see FIG. 5) determines whether the print medium is the normal paper or the transparent paper by comparing the second variance V2 with a boundary value V2m of the second variance V2. If the second variance V2 is greater than the boundary value V2m in operation S6-25, the transparent/normal paper-determining unit 20-24 determines that the print medium P is the transparent paper in operation S6-26. If the second variance V2 is less than or equal to the boundary value V2m, the transparent/normal paper-determining unit 20-24 determines that the print medium P is the normal paper in operation S6-27.

As described above, in the device to determine a print medium type, an image forming apparatus having the same device, and a method of determining the print medium type according to the present general inventive concept, a print medium can be determined using a sensor having a single light-emitting unit and a single light-receiving unit such that compatibility of parts is improved and costs are reduced. Specifically, an alignment sensor of an ink-jet printer can be used as a media sensor such that the number of sensors is reduced, thereby further reducing costs. Although the description above refers to the different types of print media including a photopaper, a normal paper, an ink-jet only paper, and a transparent paper, it should be understood that other types of print media may be used with the present general inventive concept. For example, relationships among distribution factors and variances of additional types of print media may be determined experimentally.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A device to determine a print medium type, comprising:
a media sensor including a single light-emitting unit to emit a first incident light onto a print medium and a single light-receiving unit to sense intensity of a first reflected light reflected from the first incident light by the print medium; and
a print medium-determining unit to compare the sensed intensity of light reflected from the first incident light with a first predetermined reference value and to determine the print medium accordingly.

2. The device of claim 1, wherein the predetermined reference value is 60-90% of a maximum intensity of the first incident light.

3. The device of claim 1, further comprising:
a moving unit to move the media sensor along a widthwise direction of the print medium so that the media sensor emits a second incident light at a plurality of positions along the width of the print medium and senses a plurality of corresponding intensities of light reflected from the second incident light by the print medium at each of the plurality of positions;
a C-calculating unit to calculate a distribution factor according to the plurality of corresponding intensities of the second reflected light,
wherein the print medium-determining unit compares the distribution factor with a second predetermined reference value to determine the print medium accordingly.

4. The device of claim 3, wherein the print medium-determining unit determines whether the print medium is a photopaper according to the comparison of the intensity of the first reflected light with the first predetermined reference value, and the print medium-determining unit determines whether the print medium is a transparent paper, an ink-jet only paper, or a normal paper according to the comparison of C with the second predetermined reference value.

5. The device of claim 3, wherein the second incident light has a fixed predetermined intensity.

6. The device of claim 3, wherein the plurality of corresponding intensities of the second reflected light are combined into a plurality of groups of intensities having between 3 and 8 intensity values.

7. The device of claim 1, further comprising:
a moving unit to move the media sensor along a widthwise direction of the print medium so that the media sensor emits a second incident light at a plurality of positions along the width of the print medium and senses a plurality of corresponding intensities of light reflected from the second incident light by the print medium at each of the plurality of positions;
a V1-calculating unit to calculate a first variance of the plurality of corresponding intensities by filtering the sensed plurality of corresponding intensities with respect to a first frequency area; and
an ink-jet only paper-determining unit to determine that the print medium is an ink-jet only paper if the first variance is less than a boundary value of the first variance.

8. The device of claim 7, wherein the second incident light has an intensity fixed at a predetermined value.

9. The device of claim 7, wherein the first frequency area is between 50 Hz and 100 Hz.

10. The device of claim 1, further comprising:
a moving unit to move the media sensor along a widthwise direction of the print medium so that the media sensor emits a second incident light at a plurality of positions along the width of the print medium and senses a plurality of corresponding intensities of light reflected from second incident light by the print medium at each of the plurality of positions;
a V2-calculating unit to calculate a second variance of the plurality of corresponding intensities by filtering the sensed plurality of corresponding intensities with respect to a second frequency area; and
a transparent paper-determining unit to determine that the print medium is a transparent paper if the second variance is greater than a boundary value of the second variance.

11. The device of claim 10, wherein the second frequency area is between 0 Hz and 5 Hz.

12. The device of claim 1, wherein the media sensor is disposed above the print medium, the first incident light is incident on the print medium at an incident position and is partially reflected to the light-receiving unit at a reflection angle that depends on an angle of incidence on the print medium.

13. The device of claim 1, wherein the light-emitting unit further emits a second reflected light at a plurality of positions along a width of the print medium, the light-receiving unit detects a plurality of corresponding intensities, and the print-medium determining unit determines the print medium according to distribution characteristics of the plurality of corresponding intensities.

14. An apparatus to determine a print medium type in an image forming apparatus, comprising:
a media sensor including a light emitting unit to emit a light to a print medium and a single light receiving unit to receive light reflected from the print medium; and
a print medium determining unit to determine the print medium from at least two print media types according to characteristics of the reflected light.

15. An apparatus to determine a print medium type, comprising:
a media sensor including a light emitting unit to emit a light at a plurality of different positions along a width of a print medium and a light receiving unit to receive a plurality of corresponding intensities of light reflected from the print medium; and
a print medium determining unit to determine the print medium according to distribution characteristics of the plurality of corresponding intensities.

16. The apparatus of claim 15, wherein the distribution characteristics are based on a reflectance of the print medium and a scatter density of the print medium.

17. The apparatus of claim 15, wherein the print medium determining unit determines the distribution characteristics by determining a variation between the plurality of corresponding intensities and an average of the plurality of intensities.

18. The apparatus of claim 15, wherein the print medium determining unit determines distribution characteristics by determining an average intensity value of the plurality of corresponding intensities and comparing the plurality of corresponding intensities with the average intensity value.

19. The apparatus of claim 18, wherein the print medium determining unit compares the plurality of corresponding intensities with the average intensity value by grouping the plurality of corresponding intensities into a plurality of groups of intensities, determining representative intensity values for each of the plurality of groups of intensities, and comparing the representative intensity values with the average intensity value.

20. The apparatus of claim 19, wherein the print medium determining unit plots a scatter line according to the representative intensity values for each of the plurality of groups and determines a number of times that the plotted scatter line crosses a line representing the average intensity value.

21. The apparatus of claim 19, wherein the plurality of positions include 4000 positions and each of the plurality of groups include three adjacent intensity values.

22. An image forming apparatus comprising a printer to print an image on a print medium and a device to determine a print medium type, the device to determine the print medium type comprising:
a media sensor including a single light-emitting unit to emit a first incident light onto a print medium and a single light-receiving unit to sense an intensity of light reflected from the first incident light by the print medium; and
a print medium-determining unit to compare the sensed intensity of the light reflected from the first incident light with a first predetermined reference value and to determine the print medium accordingly.

23. The apparatus of claim 22, wherein the first predetermined reference value is 60-90% of a maximum intensity of the first incident light.

24. The apparatus of claim 22, further comprising:
a moving unit to move the media sensor along a widthwise direction of the print medium so that the media sensor emits a second incident light at a plurality of positions along the width of the print medium and senses a plurality of corresponding intensities of a second reflected light reflected from the second incident light by the print medium at each of the plurality of positions;
a C-calculating unit to calculate a distribution factor according to the plurality of corresponding intensities of the second reflected light,
wherein the print medium-determining unit compares the distribution factor with a second predetermined reference value to determine the print medium accordingly.

25. The apparatus of claim 24, wherein the print medium-determining unit determines whether the print medium is a photopaper according to the comparison of the intensity of the first reflected light with the first predetermined reference value, and the print medium-determining unit determines whether the print medium is a transparent paper, an ink-jet only paper, or a normal paper according to the comparison of the distribution factor with the second predetermined reference value.

26. The apparatus of claim 24, wherein the plurality of corresponding intensities of the second reflected light are combined into a plurality of groups of intensities having between 3 and 8 intensity values.

27. The apparatus of claim 22, further comprising:
a moving unit to move the media sensor along a widthwise direction of the print medium so that the media sensor emits a second incident light at a plurality of positions along the width of the print medium and senses a plurality of corresponding intensities of light reflected from the second incident light by the print medium at each of the plurality of positions;
a V1-calculating unit to calculate a first variance of the plurality of corresponding intensities by filtering the sensed plurality of corresponding intensities with respect to a first frequency area; and
an ink-jet only paper-determining unit to determine the print medium as an ink-jet only paper if the first variance is less than a boundary value of the first variance.

28. The apparatus of claim 27, wherein the first frequency area is between 50 Hz and 100 Hz.

29. The apparatus of claim 24, further comprising:
a moving unit to move the media sensor along a widthwise direction of the print medium so that the media sensor emits a second incident light at a plurality of positions along the width of the print medium and senses a plurality of corresponding intensities of light reflected from the second incident light by the print medium at each of the plurality of positions;
a V2-calculating unit to calculate a second variance of the plurality of corresponding intensities by filtering the sensed corresponding plurality of intensities with respect to a second frequency area; and
a transparent paper-determining unit to determine the print medium is a transparent paper if the second variance is greater than a boundary value of the second variance.

30. The apparatus of claim 29, wherein the second frequency area is between 0 Hz and 5 Hz.

31. The apparatus of claim 22, wherein the media sensor is mounted on a carrier in the inkjet printer and is movable in a widthwise direction of the print medium, and a position monitor that monitors a position of a printhead in the inkjet printer provides position information to the print medium-determining unit.

32. A method of determining a print medium type, the method comprising:
performing a primary sensing operation to sense an intensity of a first light reflected from a print medium by emitting a first incident light onto the print medium; and
comparing the intensity of the first reflected light with a first predetermined reference value and determining the print medium accordingly.

33. The method of claim 32, wherein the first predetermined reference value is 60-90% of a maximum intensity of the first incident light.

34. The method of claim 32, further comprising:
performing a secondary sensing operation to sense a plurality of intensities of a second light reflected from each of a plurality of positions on the print medium by emitting a second incident light at the plurality of positions along the width of the print medium;
calculating a distribution factor according to the sensed plurality of intensities of the second reflected light; and
comparing the distribution factor with a second predetermined reference value and determining the print medium accordingly.

35. The method of claim 34, wherein:
the comparing of the intensity of the first light with the first predetermined reference value comprises determining whether the print medium is a photopaper; and
the comparing of the distribution factor with the second predetermined reference value comprises determining whether the print medium is a transparent paper, an ink-jet only paper, or a normal paper.

36. The method of claim 34, wherein the plurality of corresponding intensities of the second light are combined into a plurality of groups of intensities having between 3 and 8 intensity values.

37. The method of claim 32, further comprising:
performing a secondary sensing operation to sense a plurality of intensities of second light reflected from each of a plurality of positions on the print medium by emitting a second incident light at the plurality of positions along the width of the print medium;
calculating a first variance of the plurality of intensities of the second reflected light by filtering the sensed plurality of intensities of the second reflected light with respect to a first frequency area; and
determining the print medium as an ink-jet only paper if the first variance is less than a first boundary value of the first variance.

38. The method of claim 37, wherein the first frequency area is between 50 Hz and 100 Hz.

39. The method of claim 37, further comprising:
performing a secondary sensing operation to sense a plurality of intensities of second light reflected from each of a plurality of positions on the print medium by emitting a second incident light at the plurality of positions along the width of the print medium;
calculating a second variance of the plurality of intensities of the second reflected light by filtering the sensed plurality of intensities of the second reflected light with respect to a second frequency area; and
determining the print medium as a transparent paper if the second variance is greater than a second boundary value of the second variance.

40. The method of claim 39, wherein the second frequency area is between 0 Hz and 5 Hz.

41. A method of determining a print medium type in an image forming apparatus, the method comprising:
emitting a light to a print medium;
sensing light reflected from the print medium to a single light receiving unit; and
determining the print medium from at least two print media types according to characteristics of the sensed reflected light.

42. The method of claim 41, wherein:
the emitting of the light comprises emitting a first light to the print medium at a first position; and
the determining of the print medium comprises determining whether the print medium is a first print medium type according to whether an intensity of the light reflected from the print medium reaches a first reference value.

43. The method of claim 42, wherein:
the emitting of the light further comprises emitting a second light at a plurality of different positions along the print medium;
the sensing of the light comprises sensing a plurality of corresponding intensities of light reflected from the print medium; and
the determining of the print medium further comprises determining whether the print medium is a second print medium type, a third print medium type, or a fourth print medium type according to distribution characteristics of the plurality of corresponding intensities with respect to an average value of the plurality of corresponding intensities.

44. A method of determining a print medium type, the method comprising:
emitting a light at a plurality of different positions along a of a print medium;
receiving a plurality of corresponding intensities of light reflected from the print medium; and
determining the print medium according to distribution characteristics of the plurality of corresponding intensities.

45. The method of claim 44, wherein the distribution characteristics are based on a reflectance of the print medium and a scatter density of the print medium.

46. The method of claim 44, further comprising:
determining the distribution characteristics by determining a variation between the plurality of corresponding intensities and an average of the plurality of intensities.

47. The method of claim 44, wherein the determining of the printing medium comprises determining the distribution characteristics according to the received plurality of corresponding intensities, and the determining of the distribution characteristics comprises:
determining an average intensity value of the plurality of corresponding intensities, and
comparing the plurality of corresponding intensities with the average intensity value.

48. The method of claim 47, wherein the determining of the distribution characteristics further comprises:
comparing the plurality of corresponding intensities with the average intensity value by grouping the plurality of corresponding intensities into a plurality of groups of intensities,
determining representative intensity values for each of the plurality of groups of intensities, and
comparing the representative intensity values with the average intensity value.

49. The method of claim 48, wherein the determining of the distribution characteristic further comprises:
plotting a scatter line according to the representative intensity values for each of the plurality of groups, and
determining a number of times that the plotted scatter line crosses a line representing the average intensity value.

50. The method of claim 48, wherein the plurality of positions include 4000 positions and each of the plurality of groups include three adjacent intensity values.
